(19) United States
(12) Patent Application Publication
(10) Pub. No.: US 2012/0263093 A1
(43) Pub. Date: Oct. 18, 2012

(54) Control Channel Coordination in Heterogeneous Networks

(76) Inventors: Sabine Roessel, Munchen (DE); Frank Frederiksen, Klarup (DK); Troels Emil Kolding, Klarup (DK); Klaus Ingemann Pedersen, Aalborg (DK); Risto Juhani Mononen, Espoo (FI)

(21) Appl. No.: 13/501,945

(22) PCT Filed: Oct. 16, 2009
(86) PCT No.: PCT/EP2009/063556

§ 371 Date: Jun. 19, 2012

(51) Int. Cl. H04W 72/04; H04W 4/06; H04W 56/00

(52) U.S. Cl. 370/312; 370/330; 370/336

(57) ABSTRACT

An apparatus, method, system and computer program product provide control channel coordination in heterogeneous networks. Parameters are provided indicating the availability of resources, wherein a resource is defined as an available radio frequency per time interval, and parameters indicate configuration of a physical channel configured for downlink control, for a physical control channel configured for format indication, and for a physical channel configured for HARQ indication, for use in both of two different communication cells providing radio communication services for terminals located therein. Further, a first resource allocation set and a second resource allocation set are determined, wherein determinations of the first resource allocation set and the second resource allocation set are made to be as mutually disjoint in resource allocation as possible in consideration of the parameters.

### FIELD OF THE INVENTON

The present invention relates to an apparatus, method, system and computer program product for providing control channel coordination in heterogeneous networks.

### RELATED BACKGROUND ART

Prior art which is related to this technical field can e.g. be found by the technical specifications TS 36.211 current version: 8.8.0), TS 36.212 (current version 8.7.0), TS 36.213 (current version: 8.8.0) and TS 36.814 (current version: 1.0.0) of the 3GPP, and by the contributions document R4-093091 and document R4-093220 of the working group 4 of the 3GPP related to radio access networks.

The following meanings for the abbreviations used in this specification apply:

3GPP: 3^{rd} Generation Partnership Project

BLER: Block Error Rate

CCE: Control Channel Element

CDM: Code Division Multiplex

C-RNTI: Cell Radio Network Temporary Identifier

CRS: Common Reference Signal

DL: Downlink

eNB: evolved Node B (eNode B)

FD: Frequency Domain

FDD: Frequency Division Duplex

GPS: Global Positioning System

GSM: Global System for Mobile Communication

HARQ: Hybrid Automatic Repeat Request

HeNB: Home eNB

LA: Local Area

LOS: Line-of-Sight

LTE: Long Term Evolution

MBSFN: Multimedia Broadcast over Single Frequency Network

MIB: Master Information Block

OFDMA: Orthogonal Frequency Division Multiple Access

O&M: Operations and Maintenance

PBCH: Physical Broadcast Channel

PCFICH: Physical Control Format Indicator Channel

PCI: Physical Cell Identity

PDCCH: Physical Downlink Control Channel

PDSCH: Physical Downlink Shared Channel

PHICH: Physical HARQ Indicator Channel

PRB: Physical Resource Block

PUCCH: Physical Uplink Control Channel

PUSCH: Physical Uplink Shared Channel

RE: Resource Element

REG: Resource Element Group

SC-FDMA: Single Carrier Frequency Division Multiple Access

SIB: System Information Block

TD: Time Domain

TDD: Time Division Duplex

TTI: Transmission Time Interval

UE: User Equipment

UL: Uplink

UMTS: Universal Mobile Telecommunications System

UTRAN: UMTS Terrestrial Radio Access Network

WA: Wide Area

WiMAX: Worldwide Interoperability for Microwave Access

In recent years, 3GPP's LTE as the upcoming standard is under particular research. The base station of LTE is called eNodeB. LTE will be based on OFDMA in downlink and SC-FDMA in uplink. Both schemes allow the division of the uplink and downlink radio resources in frequency and time, i.e. specific frequency resources will be allocated for certain time duration to the different UE. The access to the uplink and downlink radio resources is controlled by the eNode B that controls the allocation of the frequency resources for certain time slots.

Furthermore, for mobile wireless communication systems such as those according to the 3GPP LTE low transmission power eNBs (which in the following are called Home eNodeBs or with a synonym meaning, femto or pico eNB) are proposed. These nodes can be operated at the same frequency layer, i.e. the same carrier frequency in the same frequency band, as a wide area eNB.

For example, on the field of Evolved UTRAN/Long-Term-Evolution (EUTRAN/LTE) and LTE-Advanced networks as well as in general in the field of wireless communication networks, a heterogeneous network is typically characterized by the combination of a Wide Area (WA) network (with macro base stations such as the above WA eNB) with an outdoor and/or an indoor Local Area (LA) network (with so-called pico or femto base stations such as the above HeNB) in the same geographical area.

However, the coexistence of WA and LA networks faces interference issues.

A rather simple method of solving interference issues consists of deploying the WA and the LA network in disjoint spectrum.

Though, since operators, in particular when having scarce spectrum, aim at enhancing overall capacity by offloading traffic into a LA network, the most desirable heterogeneous network deployment will be the co-channel deployment of the WA and the LA network. Moreover, many operators will require that co-channel deployment should be enabled within the existing LTE Release 8 standard definition.

To date co-channel deployment of WA and LA network relies on network planning:
Option 1: Home eNB/Pico eNB are deployed anyways where macro eNB coverage starts to fade.
Option 2: Home eNB/Pico eNB are deployed in buildings with high in-building penetration loss; typically at least 20 dB in-building penetration loss is assumed.
Option 3: Home eNB/Pico eNB are deployed inside an office building/a hotel/a shopping mall etc. in such a way that LOS components to the exterior are avoided.

For heavy traffic offloading, however, network planning options may not be sufficient. It is known already that in many cases more than 5 dB to 10 dB in-building penetration losses cannot be expected. Also, LA deployments may also be needed in quite low frequency bands (e.g. GSM, 800 MHz, U.S. 700 MHz, etc.) where in-building penetration has not been an issue to date.

For traffic offloading in lower frequency bands, the operator may want to allow for a rather wide-spread residential HeNB deployment or even for HeNB LA clusters inside an office building such that neither network planning Option 1 nor Option 2 or Option 3 are available while co-channel deployment is required by the operator.

The problem occurs in four use cases for co-channel deployment:
Use Case 1 - Macro network with frequency reuse 1: inter-cell interference
Use Case 2 - Massive residential HeNB: satisfactory isolation between HeNBs; in quite large parts of the macro cell interference conflicts between macro cell and femto cell
Use Case 3 - Femto cluster (office building): satisfactory isolation between macro and LA cluster; interference conflicts between femto cells inside the cluster
Use Case 4 - Hybrid case: of 2) and 3)

### SUMMARY OF THE INVENTION

It is an object of the present invention to overcome at least some of the drawbacks of the prior art.

According to a first aspect of the present invention, this is accomplished by an apparatus, comprising parameter provision means configured to provide parameter indicating the availability of resources, wherein a resource is defined as an available radio frequency per time interval, and parameter indicating the configuration of a physical channel configured for downlink control, for a physical control channel configured for format indication, and for a physical channel configured for hybrid automatic repeat request indication, respectively, for use in both of two different communication cells for providing radio communication services for terminals located in said cells; and determining means configured to determine a first resource allocation set and a second resource allocation set, wherein the first resource allocation set and the second resource allocation set respectively comprise resource allocations for a physical channel configured for downlink control, for a physical control channel configured for format indication, and for a physical channel configured for hybrid automatic repeat request indication, and wherein the determining means is configured to determine the first resource allocation set and the second resource allocation set to be as mutually disjoint in resource allocation as possible in consideration of the parameters provided by the parameter provision means.

Modifications of the first aspect may be as follows.

The apparatus according to the first aspect may be configured to be suitable for providing control channel coordination in heterogeneous networks.

The two different communication cells may be selected from a group comprising a macro communication cell and a femto or pico communication cell, or comprising two or more femto or pico communication cells in a local area deployment.

The determining means may be further configured to determine the first resource allocation set and the second resource allocation set to be as mutually disjoint in resource allocation as possible by suitably selecting a physical cell identity for the second communication cell, by filling a string of control channel elements forming the physical channel configured for downlink control of the first communication cell with dummy terminal-related control channel elements where a control channel element string of the physical channel configured for downlink control of the second communication cell has its terminal-related control channel elements and vice versa, and by controlling a terminal search space on the physical channels configured for downlink control within both communication cells based on a pre-defined set of cell radio network temporary identifier for the first communication cell and a pre-defined set of cell radio network temporary identifier for the second communication cell.

According to a second aspect of the present invention, the object is accomplished by an apparatus, comprising a parameter provision processor configured to provide parameter indicating the availability of resources, wherein a resource is defined as an available radio frequency per time interval, and parameter indicating the configuration of a physical channel configured for downlink control, for a physical control channel configured for format indication, and for a physical channel configured for hybrid automatic repeat request indication, respectively, for use in both of two different communication cells for providing radio communication services for terminals located in said cells; and a determining processor configured to determine a first resource allocation set and a second resource allocation set, wherein the first resource allocation set and the second resource allocation set respectively comprise resource allocations for a physical channel configured for downlink control, for a physical control channel configured for format indication, and for a physical channel configured for hybrid automatic repeat request indication, and wherein the determining processor is configured to determine the first resource allocation set and the second resource allocation set to be as mutually disjoint in resource allocation as possible in consideration of the parameters provided by the parameter provision means.

Modifications of the second aspect of the present invention may correspond to the modifications of the first aspect.

According to a third aspect of the present invention, the object is accomplished by an apparatus, comprising detecting means configured to detect a first resource allocation set and a second resource allocation set, wherein a resource is defined as an available radio frequency per time interval, and wherein the first resource allocation set and the second resource allocation set respectively comprise resource allocations for a physical channel configured for downlink control, for a physical control channel configured for format indication, and for a physical channel configured for hybrid automatic repeat request indication; and controlling means configured to control a power of signal transmission on the physical channels reflected in the first resource allocation set in relation to the second resource allocation set such that a power of signal transmission differs in dependency on whether resource allocations in the first resource allocation set and the second resource allocation set are disjoint.

Modifications of the third aspect may be as follows.

The apparatus according to the third aspect may be configured to be suitable for providing control channel coordination in heterogeneous networks.

The controlling means may be configured to control a power of signal transmission such that a power of signal transmission is higher where resource allocations in the first resource allocation set and the second resource allocation set are disjoint, and a power of signal transmission is lower where resource allocations in the first resource allocation set and the second resource allocation set are not disjoint.

The controlling means may be configured to control a power of signal transmission such that a power of signal transmission is lower where resource allocations in the first resource allocation set and the second resource allocation set are disjoint, and a power of signal transmission is higher where resource allocations in the first resource allocation set and the second resource allocation set are not disjoint.

According to a fourth aspect of the present invention, the object is accomplished by an apparatus, comprising a detecting processor configured to detect a first resource allocation set and a second resource allocation set, wherein a resource is defined as an available radio frequency per time interval, and wherein the first resource allocation set and the second resource allocation set respectively comprise resource allocations for a physical channel configured for downlink control, for a physical control channel configured for format indication, and for a physical channel configured for hybrid automatic repeat request indication; and a controlling processor configured to control a power of signal transmission on the physical channels reflected in the first resource allocation set in relation to the second resource allocation set such that a power of signal transmission differs in dependency on whether resource allocations in the first resource allocation set and the second resource allocation set are disjoint.

Modifications of the fourth aspect of the present invention may correspond to the modifications of the third aspect.

According to a fifth aspect of the present invention, the object is accomplished by an apparatus, comprising synchronization means configured to synchronize in time an internal channel transmission clock with an external channel transmission clock; and channel transmission means configured to introduce a time domain offset in downlink channel transmission of a physical channel configured for broadcast as well as of synchronization signals of a first communication cell with respect to downlink channel transmission of a physical channel configured for broadcast as well as of the synchronization signals of a second communication cell.

Modifications of the fifth aspect may be as follows.

The apparatus according to the fifth aspect may be configured to be suitable for providing control channel coordination in heterogeneous networks.

A given time structure of the first communication cell's channel transmission of the physical channel configured for broadcast comprising a periodically recurring pattern built on a frame-and-sub-frame⁻structure and an analogous given time structure of the second communication cell's channel transmission of the physical channel configured for broadcast may be exploited to configure a time domain offset as one frame length in time or as positive integer-multiple thereof, such that the physical channel configured for broadcast of the first and the second communication cells are interleaved and do not collide.

Each of the two or more communication cell's channel transmissions of the physical channel configured for broadcast with a time structure built on a frame structure with ten sub-frames may be configured with a mutual time domain offset which is N times the time length of one sub-frame, wherein N is a positive integer but cannot be multiples of five, and wherein in one communication cell's channel transmission a physical channel configured for shared downlink and a physical channel configured for multicast which collide in time and frequency with the other cell's channel transmission of the physical channel configured for broadcast are muted by introducing an empty multimedia broadcast over single frequency network sub-frame for each M-th frame interval time length, wherein M is a positive integer.

According to a sixth aspect of the present invention, the object is accomplished by an apparatus, comprising a synchronization processor configured to synchronize in time an internal channel transmission clock with an external channel transmission clock; and a channel transmission processor configured to introduce a time domain offset in downlink channel transmission of a physical channel configured for broadcast as well as of synchronization signals of a first communication cell with respect to downlink channel transmission of a physical channel configured for broadcast as well as of the synchronization signals of a second communication cell. Modifications of the sixth aspect of the present invention may correspond to the modifications of the fifth aspect.

According to a seventh aspect of the present invention, the object is accomplished by a method, comprising providing parameter indicating the availability of resources, wherein a resource is defined as an available radio frequency per time interval, and parameter indicating the configuration of a physical channel configured for downlink control, for a physical control channel configured for format indication, and for a physical channel configured for hybrid automatic repeat request indication, respectively, for use in both of two different communication cells for providing radio communication services for terminals located in said cells; and determining a first resource allocation set and a second resource allocation set, wherein the first resource allocation set and the second resource allocation set respectively comprise resource allocations for a physical channel configured for downlink control, for a physical control channel configured for format indication, and for a physical channel configured for hybrid automatic repeat request indication, and wherein the first resource allocation set and the second resource allocation set are determined to be as mutually disjoint in resource allocation as possible in consideration of the parameters provided by the parameter provision means.

Modifications of the seventh aspect may be as follows.

The method according to the seventh aspect may be configured to be suitable for providing control channel coordination in heterogeneous networks.

The two different communication cells may be selected from a group comprising a macro communication cell and a femto or pico communication cell, or comprising two or more femto or pico communication cells in a local area deployment.

The first resource allocation set and the second resource allocation set may be determined as mutually disjoint in resource allocation as possible by including suitably selecting a physical cell identity for the second communication cell, filling a string of control channel elements forming the physical channel configured for downlink control of the first communication cell with dummy terminal-related control channel elements where a control channel element string of the physical channel configured for downlink control of the second communication cell has its terminal-related control channel elements and vice versa, and controlling a terminal search space on the physical channels configured for downlink control within both communication cells based on a predefined set of cell radio network temporary identifier for the first communication cell and a pre-defined set of cell radio network temporary identifier for the second communication cell.

The method according to the seventh aspect or any of its modifications may be performed by the apparatus according to the first or second aspect or suitable ones of their modifications.

According to an eighth aspect of the present invention, the object is accomplished by a method, comprising detecting a first resource allocation set and a second resource allocation set, wherein a resource is defined as an available radio frequency per time interval, and wherein the first resource allocation set and the second resource allocation set respectively comprise resource allocations for a physical channel configured for downlink control, for a physical control channel configured for format indication, and for a physical channel configured for hybrid automatic repeat request indication; and controlling a power of signal transmission on the physical channels reflected in the first resource allocation set in relation to the second resource allocation set such that a power of signal transmission differs in dependency on whether resource allocations in the first resource allocation set and the second resource allocation set are disjoint.

Modifications of the eighth aspect may be as follows.

The method according to the eighth aspect may be configured to be suitable for providing control channel coordination in heterogeneous networks.

The controlling may further include controlling a power of signal transmission such that a power of signal transmission is higher where resource allocations in the first resource allocation set and the second resource allocation set are disjoint, and a power of signal transmission is lower where resource allocations in the first resource allocation set and the second resource allocation set are not disjoint.

The controlling may further include controlling a power of signal transmission such that a power of signal transmission is lower where resource allocations in the first resource allocation set and the second resource allocation set are disjoint, and a power of signal transmission is higher where resource allocations in the first resource allocation set and the second resource allocation set are not disjoint.

The method according to the eighth aspect or any of its modifications may be performed by the apparatus according to the third or fourth aspect or suitable ones of their modifications.

According to a ninth aspect of the present invention, the object is accomplished by a method, comprising synchronizing in time an internal channel transmission clock with an external channel transmission clock; and introducing a time domain offset in downlink channel transmission of a physical channel configured for broadcast as well as of synchronization signals of a first communication cell with respect to downlink channel transmission of a physical channel configured for broadcast as well as of the synchronization signals of a second communication cell.

Modifications of the ninth aspect may be as follows.

The method according to the ninth aspect may be configured to be suitable for providing control channel coordination in heterogeneous networks.

A given time structure of the first communication cell's channel transmission of the physical channel configured for broadcast comprising a periodically recurring pattern built on a frame-and-sub-frame-structure and an analogous given time structure of the second communication cell's channel transmission of the physical channel configured for broadcast may be exploited to configure a time domain offset as one frame length in time or as positive integer-multiple thereof, such that the physical channel configured for broadcast of the first and the second communication cells are interleaved and do not collide.

Each of the two or more communication cell's channel transmissions of the physical channel configured for broadcast with a time structure built on a frame structure with ten sub-frames may be configured with a mutual time domain offset which is N times the time length of one sub-frame, wherein N is a positive integer but cannot be multiples of five, and wherein in one communication cell's channel transmission a physical channel configured for shared downlink and a physical channel configured for multicast which collide in time and frequency with the other cell's channel transmission of the physical channel configured for broadcast are muted by introducing an empty multimedia broadcast over single frequency network sub-frame for each M-th frame interval time length, wherein M is a positive integer.

The method according to the ninth aspect or any of its modifications may be performed by the apparatus according to the fifth or sixth aspect or suitable ones of their modifications.

According to a tenth aspect of the present invention, the object is accomplished by an evolved Node B, comprising an apparatus according to the third to sixth aspect of the present invention or any one of their modifications.

According to an eleventh aspect of the present invention, the object is accomplished by a central network entity, comprising an apparatus according the first or second aspect of the present invention or any one of their modifications.

According to a twelfth aspect of the present invention, the object is accomplished by a computer program product comprising computer-executable components which perform, when the program is run on a computer providing parameter indicating the availability of resources, wherein a resource is defined as an available radio frequency per time interval, and parameter indicating the configuration of a physical channel configured for downlink control, for a physical control channel configured for format indication, and for a physical channel configured for hybrid automatic repeat request indication, respectively, for use in both of two different communication cells for providing radio communication services for terminals located in said cells; and determining a first resource allocation set and a second resource allocation set, wherein the first resource allocation set and the second resource allocation set respectively comprise resource allocations for a physical channel configured for downlink control, for a physical control channel configured for format indication, and for a physical channel configured for hybrid automatic repeat request indication, and wherein the first resource allocation set and the second resource allocation set are determined to be as mutually disjoint in resource allocation as possible in consideration of the parameters provided by the parameter provision means.

Modifications of the twelfth aspect may be as follows.

The computer program product according to the twelfth seventh aspect may be suitable for providing control channel coordination in heterogeneous networks.

The computer program product according to the twelfth aspect may be embodied as a computer-readable storage medium.

The determining the first resource allocation set and the second resource allocation set to be as mutually disjoint in resource allocation as possible may include suitably selecting a physical cell identity for the second communication cell, filling a string of control channel elements forming the physical channel configured for downlink control of the first communication cell with dummy terminal-related control channel elements where a control channel element string of the physical channel configured for downlink control of the second communication cell has its terminal-related control channel elements and vice versa, and controlling a terminal search space on the physical channels configured for downlink control within both communication cells based on a pre-defined set of cell radio network temporary identifier for the first communication cell and a pre-defined set of cell radio network temporary identifier for the second communication cell.

Otherwise, modifications of the twelfth aspect may correspond to the modifications of the seventh aspect.

According to a thirteenth aspect of the present invention, the object is accomplished by a computer program product comprising computer-executable components which perform, when the program is run on a computer detecting a first resource allocation set and a second resource allocation set, wherein a resource is defined as an available radio frequency per time interval, and wherein the first resource allocation set and the second resource allocation set respectively comprise resource allocations for a physical channel configured for downlink control, for a physical control channel configured for format indication, and for a physical channel configured for hybrid automatic repeat request indication; and controlling a power of signal transmission on the physical channels reflected in the first resource allocation set in relation to the second resource allocation set such that a power of signal transmission differs in dependency on whether resource allocations in the first resource allocation set and the second resource allocation set are disjoint.

Modifications of the thirteenth aspect may be as follows.

The computer program product according to the thirteenth aspect may be suitable for providing control channel coordination in heterogeneous networks.

The computer program product according to the thirteenth aspect may be embodied as a computer-readable storage medium.

Otherwise, modifications of the thirteenth aspect may correspond to the modifications of the eighth aspect.

According to a fourteenth aspect of the present invention, the object is accomplished by a computer program product comprising computer-executable components which perform, when the program is run on a computer synchronizing in time an internal channel transmission clock with an external channel transmission clock; and introducing a time domain offset in downlink channel transmission of a physical channel configured for broadcast as well as of synchronization signals of a first communication cell with respect to downlink channel transmission of a physical channel configured for broadcast as well as of the synchronization signals of a second communication cell.

Modifications of the fourteenth aspect may be as follows.

The computer program product according to the fourteenth aspect may be suitable for providing control channel coordination in heterogeneous networks.

The computer program product according to the fourteenth aspect may be embodied as a computer-readable storage medium.

Otherwise, modifications of the fourteenth aspect may correspond to the modifications of the ninth aspect.

It is to be understood that any of the above modifications can be applied singly or in combination to the respective aspects to which they refer, unless they are explicitly stated as excluding alternatives.

### BRIEF DESCRIPTION OF THE DRAWINGS

The above and other objects, features, details and advantages will become more fully apparent from the following detailed description of the preferred embodiments which is to be taken in conjunction with the appended drawings, in which:

FIG. 1 shows a WA-to-LA and LA-to-LA coexistence model;

FIG. 2 shows a first example of an apparatus according to certain embodiments of the present invention;

FIG. 3 shows a second example of an apparatus according to certain embodiments of the present invention;

FIG. 4 shows a third example of an apparatus according to certain embodiments of the present invention;

FIG. 5 shows a first example of a method according to certain embodiments of the present invention;

FIG. 6 shows a second example of a method according to certain embodiments of the present invention;

FIG. 7 shows a third example of a method according to certain embodiments of the present invention;

FIG. 8 shows a fragment of complementary PDCCH mappings according to certain embodiments of the present invention; and

FIG. 9 illustrates different time offset techniques according to certain embodiments of the present invention.

### DETAILED DESCRIPTION OF THE PREFERRED EMBODIMENTS

In the following, description is made to what are presently considered to be preferred embodiments of the present invention. It is to be understood, however, that the description is given by way of example only, and that the described embodiments are by no means to be understood as limiting the present invention thereto.

For example, for illustration purposes, in some of the following exemplary embodiments, interference reduction between a 3GPP LTE overlay wide area macro network and a 3GPP LTE local area network is described. However, it should be appreciated that these exemplary embodiments are not limited for use among these particular types of wireless communication systerns, and according to further exemplary embodiments, the present invention can be applied also to other types of communication systems and access networks such as e.g. to WLAN (wireless local area network) and WIMAX (worldwide interoperability for microwave access) techniques and standards.

Thus, certain embodiments of the present invention relate to mobile wireless communication systems, such as 3GPP LTE. In more detail, certain embodiments of the present invention are related to the configuration of Both LTE eNB and low transmission power eNBs which are in the following called Home eNodeBs (HeNBs), and the case where these nodes are operated at the same frequency layer, i.e. at the same carrier frequency in the same frequency band, as the wide area eNBs.

However, as indicated above, the present invention is not limited to HeNB, but other embodiments of the present invention are related to general small nodes with local services applied, and which are under an overlay wide area macro network operated on the same frequency layer.

FIG. 2 shows a principle configuration of a first example for an apparatus according to certain embodiments of the present invention. One option for implementing the first example for an apparatus according to certain embodiments of the present invention would be a central network entity such as an operation and maintenance functionality.

Specifically, as shown in FIG. 2, the first example for an apparatus 1 comprises a parameter provision processor 21 configured to provide parameter indicating the availability of resources, wherein a resource is defined as an available radio frequency per time interval, and parameter indicating the configuration of a physical channel configured for downlink control, for a physical control channel configured for format indication, and for a physical channel configured for hybrid automatic repeat request indication, respectively, for use in both of two different communication cells for providing radio communication services for terminals located in said cells; and a determining processor 22 configured to determine a first resource allocation set and a second resource allocation set, wherein the first resource allocation set and the second resource allocation set respectively comprise resource allocations for a physical channel configured for downlink control, for a physical control channel configured for format indication, and for a physical channel configured for hybrid automatic repeat request indication, and wherein the determining processor is configured to determine the first resource allocation set and the second resource allocation set to be as mutually disjoint in resource allocation as possible in consideration of the parameters provided by the parameter provision means.

FIG. 3 shows a principle configuration of a second example for an apparatus according to certain embodiments of the present invention. One option for implementing the second example for an apparatus according to certain embodiments of the present invention would be an evolved Node B or a Home evolved Node B such as a femto or pico eNB.

Specifically, as shown in FIG. 3, the second example for an apparatus 2 comprises a detecting processor 33 configured to detect a first resource allocation set and a second resource allocation set, wherein a resource is defined as an available radio frequency per time interval, and wherein the first resource allocation set and the second resource allocation set respectively comprise resource allocations for a physical channel configured for downlink control, for a physical control channel configured for format indication, and for a physical channel configured for hybrid automatic repeat request indication; and a controlling processor 34 configured to control a power of signal transmission on the physical channels reflected in the first resource allocation set in relation to the second resource allocation set such that a power of signal transmission differs in dependency on whether resource allocations in the first resource allocation set and the second resource allocation set are disjoint.

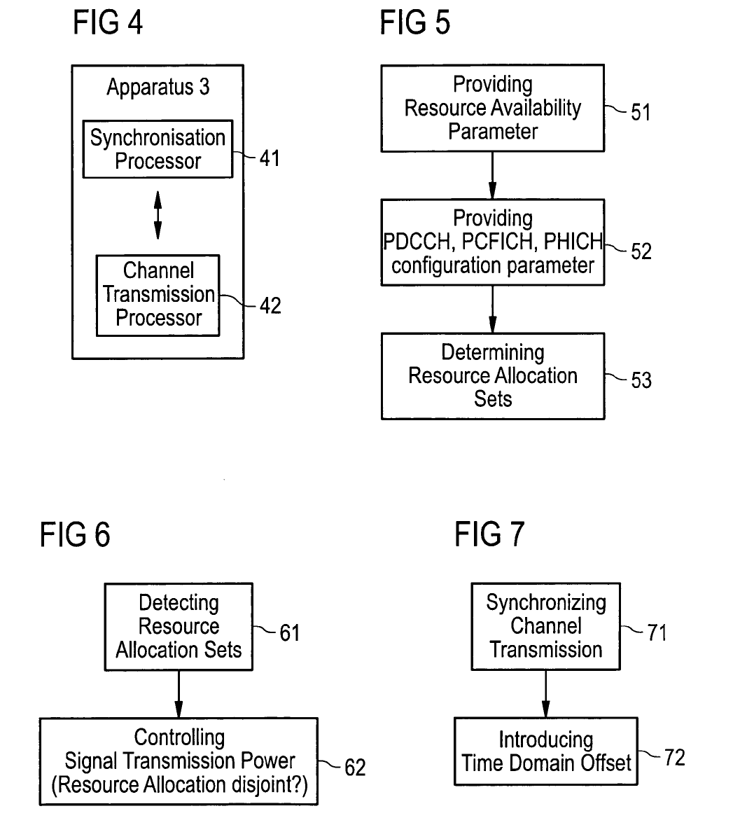

FIG. 4 shows a principle configuration of a third example for an apparatus according to certain embodiments of the present invention. One option for implementing the third example for an apparatus according to certain embodiments of the present invention would be an evolved Node B or a Home evolved Node B such as a femto or pico eNB.

Specifically, as shown in FIG. 4, the third example for an apparatus 3 comprises a synchronization processor 41 configured to synchronize in time an internal channel transmission clock with an external channel transmission clock; and a channel transmission processor 42 configured to introduce a time domain offset in downlink channel transmission of a physical channel configured for broadcast as well as of synchronization signals of a first communication cell with respect to downlink channel transmission of a physical channel configured for broadcast as well as of the synchronization signals of a second communication cell.

FIG. 5 shows a principle flowchart of a first example for a method according to certain embodiments of the present invention. That is, as shown in FIG. 5, a method comprises providing 51 parameter indicating the availability of resources, wherein a resource is defined as an available radio frequency per time interval, and parameter 52 indicating the configuration of a physical channel configured for downlink control, for a physical control channel configured for format indication, and for a physical channel configured for hybrid automatic repeat request indication, respectively, for use in both of two different communication cells for providing radio communication services for terminals located in said cells;

and determining 53 a first resource allocation set and a second resource allocation set, wherein the first resource allocation set and the second resource allocation set respectively comprise resource allocations for a physical channel configured for downlink control, for a physical control channel configured for format indication, and for a physical channel configured for hybrid automatic repeat request indication, and wherein the first resource allocation set and the second resource allocation set are determined to be as mutually disjoint in resource allocation as possible in consideration of the parameters provided by the parameter provision means.

One option for performing the first example of a method according to certain embodiments of the present invention would be to use apparatus 1 as described above or a modification thereof which becomes apparent from the embodiments as described herein below.

FIG. 6 shows a principle flowchart of a second example for a method according to certain embodiments of the present invention. That is, as shown in FIG. 6, a method comprises detecting 61 a first resource allocation set and a second resource allocation set, wherein a resource is defined as an available radio frequency per time interval, and wherein the first resource allocation set and the second resource allocation set respectively comprise resource allocations for a physical channel configured for downlink control, for a physical control channel configured for format indication, and for a physical channel configured for hybrid automatic repeat request indication; and controlling 62 a power of signal transmission on the physical channels reflected in the first resource allocation set in relation to the second resource allocation set such that a power of signal transmission differs in dependency on whether resource allocations in the first resource allocation set and the second resource allocation set are disjoint.

One option for performing the second example of a method according to certain embodiments of the present invention would be to use apparatus 2 as described above or a modification thereof which becomes apparent from the embodiments as described herein below.

FIG. 7 shows a principle flowchart of a third example for a method according to certain embodiments of the present invention. That is, as shown in FIG. 7, a method comprises synchronizing 71 in time an internal channel transmission clock with an external channel transmission clock; and introducing 72 a time domain offset in downlink channel transmission of a physical channel configured for broadcast as well as of synchronization signals of a first communication cell with respect to downlink channel transmission of a physical channel configured for broadcast as well as of the synchronization signals of a second communication cell.

One option for performing the third example of a method according to certain embodiments of the present invention would be to use apparatus 3 as described above or a modification thereof which becomes apparent from the embodiments as described herein below.

In the following, for illustration purposes, certain embodiments of the present invention are described by referring to control channel coordination in heterogeneous networks.

If cells compete in co-channel deployment and none of the network planning options as described in the introductory part is sufficient, in a first approach the following two types of solutions can be considered:
Group 1: Control of the HeNB's maximum transmission power as well as automatic detection mechanisms for whether there are macro UE in the vicinity of the LA.
Group 2: Furthermore, coordination schemes to co-channel deployment of WA and LA can be considered, focusing on
   Mutual interference of shared channels PDSCH and PUSCH;
   Mutual interference of selected DL and UL control channels: R4-093220 and R4-093091 describe some control channel conflict resolutions. However, inter-cell interference coordination for PDCCH has not been tackled, and also not for the set of PDCCH, PCFICH, and PHICH as a whole. Further coordination measures are covered in relay standardization work for LTE-Advanced; for example empty MBSFNs are exploited for relay node backhaul (see TR36.814).

However, the first group (Group 1) of solutions does not solve the macro to macro cell or macro to femto cell interference problem, and is therefore only partly applicable.

The second group (Group 2) of solutions supports all four use cases (see above), but none of the prior work has provided a full set of coordination measures and schemes.

According to certain embodiments of the present invention, co-channel deployment coordination based on groups or pairs of allocation sets is proposed. Two allocation sets are perfect if they are 100% mutually disjoint in frequency and/or time. Two allocation sets are imperfect if they are as mutually disjoint as possible in frequency and/or time. This allocation set based method is compliant to LTE Release 8 and allows for mitigating all kinds of wide area (WA) and local area (LA) interference cases as described in the above use cases 1 to 4.

According to certain embodiments of the present invention, a coordination of PDCCH, PCFICH, and PHICH is based on pairs or groups of imperfect (close to perfect) allocation sets. Furthermore, a combination of PBCH synchronization and time shift in the femto cell and provision of empty MBSFN sub-frames in the macro cell to protect the femto synchronization phase is provided.

Such a (offline) coordination based on pairs (or groups) of allocation sets (which are as mutually disjoint in frequency and time as possible) supporting in particular the above use case 2 and use case 3 (and thus also the hybrid use case 4).

According to such embodiments, a concept of a femto friendly macro cell “hosting” can be implemented with a femto cell deployment without additional or dynamic coordination actions needed in the macro cell.

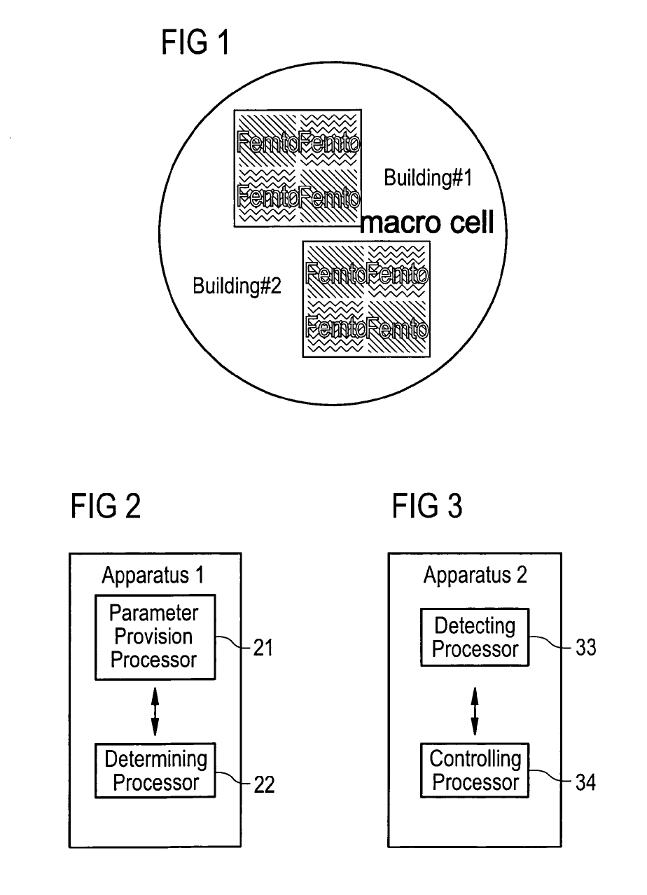

FIG. 1 shows the hybrid case use case 4, i.e. a co-channel coexistence of a macro cell with femto cells in building#1 and in building#2. The macro cell and all femto cells are using the same LTE channel. Interference issues are limited as much as possible by avoiding frequency and time domain collisions.

The co-channel control channel coordination of use case 4 can be established by defining
a group of two major (1 for all femtos and 1 for the macro cell) co-channel (as mutually disjoint and collision free as possible) frequency (sub-carrier) and time domain (sub-frame) allocation sets, and
inside the femto allocation set, for all femto's multiple minor femto allocation sets.

According to certain embodiments of the present invention, the introduction of perfect (imperfect) groups or pairs of allocation sets is based on:
3GPP standard-compliant frequency synchronization and proper channel allocation; and
time synchronization between interfering cells which can be established as follows:
   The HeNB has a (UE-) receiver to decode the macro cell's synchronization channel or another HeNB's synchronization channel.
   (At least one) HeNB in a femto cluster has a GPS receiver.
   The synchronized HeNB propagates the timing synchronization into the femto cluster based on the IEEE 1588 protocol. The IEEE 1588 protocol is then used in the way it was originally designed, i.e. implementing the protocol in all intermediate nodes (called transparent clocks or boundary clocks). With an on-path support +/−500 ns (10% of normal cyclic prefix) are achievable across a wide area network.

It is assumed that a residential HeNB or a femto cluster adapts to the time of the macro cell, and that frequency channel assignment in the residential HeNB and the femto cluster are within the 3GPP specifications.

In the following Table 1, control channel coordination schemes for creating a complete resolution mechanism in order to overcome interference issues between macro cells and femto cells are summarized, representing certain embodiments of the present invention.

TABLE 1
Collisions between femto and macro allocation sets

| Potential | | | | | | | |
|---|---|---|---|---|---|---|---|
| co- | | | | | | | |
| channel | Macro | Macro | Macro | Macro | Macro | Macro | |
| collisions | PDSCH | PDCCHs | PCFICH | PHICH | PBCH | Synch | Macro CRS |
| Femto | PDSCH | TTI | No issue | TTI | Time | Time | Physical |
| PDSCH | scheduling | synch + | with | synch + | shift | shift | Cell ID (PCI) |
| | constraints | fixed # | TTI level | fixed # | (section | (section | selection |
| | (Fractional | PDCCH | synch. | PDCCH | 2.4a) | 2.4b) | (section 2.3) |
| | frequency | OFDM | | OFDM | OR | | |
| | re-use) | (section | | (section | (section | | |
| | (section 1.) | 2.1) | | 2.1) | 2.4b) | | |

| | | | |
|---|---|---|---|
| Femto | TTI synch + | PDCCH/PCFICH/PHICH | No issue with TTI |
| PDCCHs | fixed # | allocation sets (section 2.2) | level synch. |
| | PDCCH | | |
| | OFDM | | |
| | (section | | |
| | 2.1) | | |
| Femto | No issue | | |
| PCFICH | with TTI | | |
| | level | | |
| | synch. | | |
| Femto | TTI | | |
| PHICH | synch + | | |
| | fixed # | | |
| | PDCCH | | |
| | OFDM | | |
| | (section | | |
| | 2.1) | | |

| | | | | |
|---|---|---|---|---|
| Femto | Time shift | No issue with TTI level synch. | Time | No issue |
| PBCH | and empty | | shift | with TTI |
| | MBSFN | | (section | level |
| | (section | | 2.4a) | synch |
| | 2.4a and | | | |
| | 2.4c) OR | | | |
| | (section | | | |
| | 2.4b) | | | |
| Femto | Time shift | | No issue | Time |
| Synch | (section | | with | shift |
| | 2.4b) | | TTI | (section |
| | | | level | 2.4b) |
| | | | synch | |

| | |
|---|---|
| Femto | Specific PCI selection (section 2.3) |
| CRS | |

Herein below, the embodiments depicted in Table 1 are described in further detail. It is to be noted that each section or subsection may represent an independent embodiment or even a plurality of independent embodiments. However, more than one of these embodiments may be advantageously combined or brought into interaction with each other, in particular where indicated.

1. PDSCH Scheduling Constraints

The macro eNB's scheduler as well as the femto scheduler(s) all get “reserved” PDSCH areas for frequency-selective scheduling. An alignment of the resource allocation types may be needed for this purpose. Alignment and reservation are configured semi-statically in order to be able to react on traffic imbalance between macro cell and femto network.

In case of relative side system bandwidths available for LTE operation, one could define three frequency bands for “free to use”, “can be used for additional traffic”, and “do not use”, which is coordinated between the eNBs and HeNBs. This configuration allows for relative controlled interference patterns on the PDSCH while allowing for a certain amount of guaranteed traffic in each cell. The “can be used for additional traffic”-frequency bands could potentially also be combined with a restriction on the maximum transmit power.

2.1 TTI Level Synchronization, PCFICH Static

In order to further resolve collisions in the PDCCH/PHICH/PCFICH TTI area, PCFICH is fixed to a semistatically configured number of OFDM symbols.

2.2 Interference Mitigation for PDCCH/PCFICH/PHICH Interfering with PDCCH/PCFICH/PHICH Based on (Partially) Frequency and Time Disjoint Allocation Sets

The encoded contents of Physical Downlink Control Channels (PDCCH) of UEs scheduled in the present TTI are assembled, interleaved, and mapped to resources in such a way that the PDCCH of a UE is spread over the channel bandwidth in pieces of mini Control Channel Elements (mini-CCEs) or Resource Element Groups (REGs). For details, reference is made to TS 36.211 and TS 36.213.

The encoding on the PDCCH-carrying OFDM symbols can be done as follows: all encoded PDCCH are assembled and mapped to a string of mini-CCEs while tree aggregation rules apply that a PDCCH must start in a repetitive pattern of L*9 mini-CCEs (where L can be 1, 2, 4, or 8 and corresponds to the aggregtion or robustness level of the PDCCH encoding). The start position of the UE in the mini-CCE string depends on its
C-RNTI, or the
Common C-RNTI, and the
Sub-frame Number.

After assembly of the mini-CCE string, it is mapped to REGs. The mapping depends on
the position of the mini-CCE in the PDCCH assembly after interleaving,
the Physical Cell ID (PCI), and
the positions of the PCFICH and PHICH.

The mini-CCE chain mapping onto REGs is “floating” around the fixed positions of the PCFICH and PHICH, while the resource mappings of the PCFICH and the PHICH again depend on
the Physical Cell ID (PCI).

Coordinating the PDCCH/PCFICH/PHICH of the femto deployment with the PDCCH/PCFICH/PHICH of the macro cell is done as follows: The mini-CCE string created in the macro cell as well as the mini-CCE strings in the femto deployment shall follow semi-statically pre-defined allocation patterns that are mutually as disjoint in frequency and time as possible. This allows for avoiding mutual interference by avoiding collisions of macro cell REGs with femto cell REGs. Albeit 100% collision-free allocation patterns are rare and rather improbable, but
the number of collisions can be controlled to be as low as possible (see the following sections), and
the position of the collisions is (together with the pre-defined allocation patterns) known to the macro cell in advance.

Hence, assuming a macro to femto split of the overall level of mutual macro-to-femto interference on PDCCH/PCFICH/PHICH can be reduced by 70% to 80%, the remaining known 30% down to 20% collision positions can be mitigated by profiling the macro cell's DL power mask accordingly (low power transmission by macro cell base station, i.e. eNB). Vice versa, the DL power mask of the femto cell may be profiled in a complementary manner. It is to be noted that in the femto-to-macro interference direction, it is estimated that the overall interference level on PDCCH/PCFICH/PHICH can be reduced by more than 90%.

Ultimately, the macro cell does not need to adhere to the pre-defined allocation pattern (i.e. the macro cell may allocate all mini-CCEs), but the Macro cell can exploit its knowledge about the femto deployment allocation patterns to profile its DL power mask to help the femto deployment.

In the following, it is explained how the pre-defined allocation patterns can be created. This can be done in advance in an O&M center after macro cell network planning was done and when the operator has decided which macro cells must “host” massive femto deployment (use case 2, use case 3, and use case 4) based on LTE Rel-8 backward compatible control channel coordination.

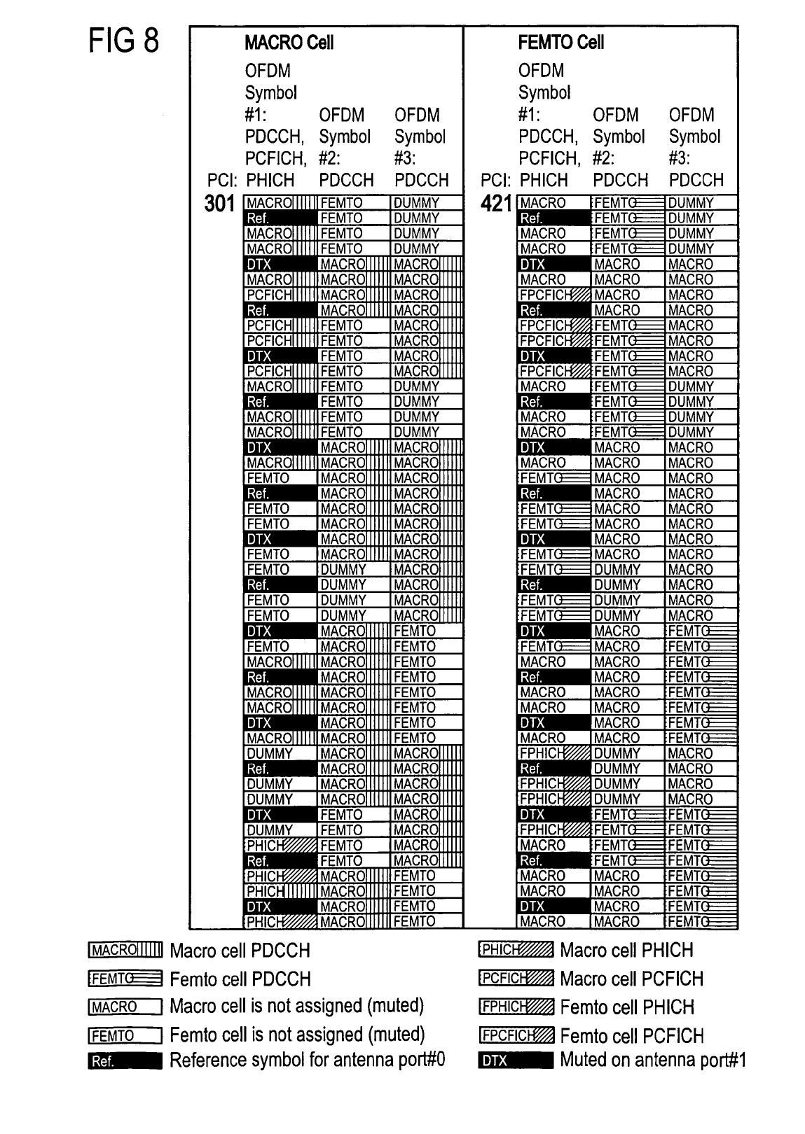

Specifically, the mechanisms to create pre-defined allocation patterns can be as follows, wherein FIG. 8 shows an example of PDCCH/PCFICH/PHICH coordination including the macro cell's power profile:

1 Same fixed number of PDCCH symbols: Assume a fixed number of (most likely 3) OFDM symbols for PDCCH in the macro cell as well as in the femto deployment, hence the contents of PCFICHs are the same both in the macro cell and in the femto deployment.

2 Fixed number of PHICH: Assume a fixed number of PHICH mini-CCEs in macro and in femto deployment (not necessarily the same amount).

3 Mutually reserved fixed number of mini-CCEs for macro and femto deployment: It is assumed that the femto PDCCH will not be thinly populated. Thus, a fixed number of mini-CCEs is reserved for the femto deployment, potentially filled with DUMMY mini-CCEs. For example, in 3 MHz there are (120-4 -3* PHICH-mini-CCEs) mini-CCEs available for PDCCH. For example, as little as 36 mini-CCEs (L=8 times 9 mini-CCEs) could be reserved for the femto deployment in use case 2. For use cases 3 and 4, at least more mini-CCEs should be reserved. The fixed remainder of mini-CCEs, potentially filled with DUMMY mini-CCEs, can be given to the macro cell. In a 3 MHz implementation the macro cell then has (120 - 36-2* (4 - 3* PHICH-mini-CCEs)) mini-CCEs for its use. For use case 3, the femto resources could take up to 50%, for use case 2 the femto resources should not exceed 33%.

4 Very limited pre-defined and reserved C-RNTIs for femto deployment: In the femto deployment, a very limited predefined set of C-RNTI's is used and the C-RNTI's are chosen in such a way that the set is aligned, or in a similar manner, for a given macro cell to femto deployment a sub-frame alignment or time shift in the UE PDCCH search space creation can be effected. This may not be 100% collision-free, but can be optimized to be collision-free for as many TTIs as possible. For connection setup the UE will use its temporary C-RNTI. In this case, the network may not be able to control the position of the temporary C-RNTI in the PDCCH mini-CCE string such that collisions between macro cell and femto cell occur on random resources. In this case, the femto DL power profiling and a high aggregation level can be used to compensate the macro to femto PDCCH interference. As soon as the C-RNTI is provided by the eNB, the level of collisions is under control and the femto PDCCH can be optimized thanks to this coordination.

5 Creating complementary PDCCH mini-CCE strings both in macro and in femto: The macro mini-CCE string is created in a pre-defined way by using non-transmitted dummy UEs/mini-CCEs where the femto mini-CCEs are reserved.

6 Limited set of femto PCIs “compliant” to macro PCIs: The femto PCI set is pre-calculated in the O&M center in such a way that an as small as possible level of collisions between the macro cell's PDCCH/PCFICH/PHICH and the femto cell's PDCCH/PCFICH/PHICH is generated when combining one out of this set of PCIs with the macro cell's PCI.
a) Construction of Femto PCI set members based on (almost) identical cyclic shift:
Collision avoidance PCI sets can be constructed by creating as little as possible perturbation from PCFICH and PHICH on otherwise identically cyclically shifted uniform PDCCH mini-CCE strings.
FIG. 8 shows an example illustrating a fragment of complementary PDCCH mappings based on constructed collision avoidance by PCI_Femto=PCI_Macro+n 120, with n=1, 2, 3. In FIG. 8, 21% of the femto PDCCH resources are interfered by the Macro cell. The macro cell powers down on its macro PDCCH resources where in conflict with the femto cell.
All PCIs with a distance of 120 create such an (almost)-identity operation on the PDCCH mapping. This method applies for 3 MHz and 5 MHz in 2 and 3 OFDM symbol configurations, in 10 MHz for 1 or 2 OFDM symbols per PDCCH, and in 20 MHz mainly for 1 OFDM symbol per PDCCH (see Table 2 for details).
The (almost)-identity operation on the PDCCH mapping often implies that the PCFICH of the macro cell and the PCFICH of the femto cell collide. In many cases such a collision should be avoided as the PCFICH may be the weakest link when expecting BLER of less than 0.1%.
In this case a rather exhaustive search as described below could be applied:
b) Construction of femto PCI set members based on exhaustive search:
Collision avoidance PCI sets can be found by searching on PDCCH mini-CCE string and PCI combinations (offline process in the O&M center). For example, a pair of imperfect allocation sets can be built for 3 OFDM symbols in a 20 MHz channel which creates again only 18% interference on femto resources (33% of all resources) and 95% collisionfree macro cell resources (67% of all resources).
If a selected femto PCI is n*12 apart from the macro PCI, common reference symbols collide. Depending on the position of the femto in the macro cell, this may be a problem for the femto cell (see also section 2.3).

TABLE 2
Construction of PCI sets for collision avoidance

| | 3 MHz | 5 MHz | 10 MHz | 20 MHz |
|---|---|---|---|---|
| 1 OFDM | Not | Not reasonable | 100 REGs: | 200 REGs: |
| Symbols | reasonable | | 4 Femto | 2 Femto PCIs |
| | | | PCIs per | per Macro |
| | | | Macro PCI | PCI |
| 2 OFDM | 75 REGs: | 125 REGs: | 250 REGs: | 500 REGs: |
| Symbols | 6 Femto | 4 Femto | 2 Femto | 1 Femto PCIs |
| | PCIs per | PCIs per | PCIs per | per Macro |
| | Macro PCI | Macro PCI | Macro PCI | PCI |
| 3 OFDM | 120 REGs: | 200 REGs: | 400 REGs: | Not applicable |
| Symbols | 3 Femto | 2 Femto | 1 Femto | |
| | PCIs per | PCIs per | PCI per | |
| | Macro PCI | Macro PCI | Macro PCI | |

2.3 Avoiding CRS Collisions by PCI Selection

PCIs can be selected in a network for squeezing active downlink bandwidth. The PCI selection can be controlled in such a way that collision scenarios are controlled. It is assumed that a direct overlap of PCIs of the macro cell and the femto cell should be avoided.

2.4a PBCH Offset/Sync Offset between Femto and Macro Allocation Sets in 10 ms Granularity

The Physical Broadcast Channel (PBCH) is transmitted within a 10 ms pattern. The MIB and SIB1 information periodicity of this information can be configured and is typically 40 ms.

Hence, the PBCH channel can be time-multiplexed by establishing a 10-ms-granular offset between the femto cell and the macro cell. With a periodicity of 40 ms, 4 different PBCH time schemes could run in parallel.

This will lead to colliding primary and secondary synchronization signals between the femto and the macro allocation set which corresponds to potential collisions at the cell edge for a frequency reuse 1 network. Due to the unique scrambling sequences a separation of the synchronization signals is possible, while on the other hand a significant interference must be accepted.

One alternative option here is to have 3 of the 4 PBCH reserved for macro operation, while the last is reserved for pico/femto operation. Given that there is a relative low code rate on the PBCH, this could also be a valid approach, but can require a per-10-ms coordination between eNBs and HeNBs.

The advantage of this approach is that none of the shared channels will be affected.

2.4b PBCH Offset/Sync Offset between Femto and Macro Allocation Sets in 1 ms Granularity (not 5 ms)

Such a time-disjoint pattern will completely resolve the collision of the PBCH and synchronization signals, while both shared channels would have to be punctured whenever a full band allocation is aimed at. If not, PDSCH allocation may avoid as often as possible the six center PRBs for allocation. Again, one could consider reserving a set of time offsets within the new set of 40 possibilities for creating a separation between macro operation and HeNB operation.

2.4c Protection of Femto PBCH/Sync from Macro PBCH/Sync and Macro PDSCH at the same Time by Empty PMCH Sub-Frame(s) in the Macro Cell for Offsets in 1 ms Granularity (not Multiple of 5 ms)

This kind of coordination extends the coordination measure of 2.4b and allows for protecting the femto PBCH/sync from macro PBCH/sync interference and macro PDSCH interference at the same time.

The following PMCH rules are considered:
PMCH shall not be transmitted in sub-frames 0 (slots 0 and 1) and 5 (slots 10 and 11) on a carrier supporting a mix of PDSCH and PMCH transmission
Number of PDCCHs supported:

TABLE 3
excerpt from Table 6.7-1 of TS 36.211 v8.8.0: Number
of OFDM symbols used for PDCCH

| | Number of |
|---|---|
| | OFDM symbols |
| | for PDCCH when |
| Subframe | N_{RB}^{DL} > 10 |
| Subframe 1 and 6 for frame structure | 1, 2 |
| type 2 | |
| MBSFN subframes on a carrier supporting | 1, 2 |
| both PMCH and PDSCH for 1 or 2 cell specific | |
| antenna ports | |
| MBSFN subframes on a carrier supporting | 2 |
| both PMCH and PDSCH for 4 cell specific | |
| antenna ports | |
| MBSFN subframes on a carrier not supporting | 0 |
| PDSCH | |
| All other cases | 1, 2, 3 |

Any time domain offset other than multiples of 5 ms avoids collisions of the femto PBCH/sync with the macro PBCH/sync.

The macro cell is configured to send empty MBSFN sub-frames e.g. for its sub-frames #1 and #6, while femto deployment aligns its sub-frames #0 and #5 with the macro cell's #1 and #6. In doing this, the femto cell UEs are not interfered when listening to the femto cell's PBCH/sync.

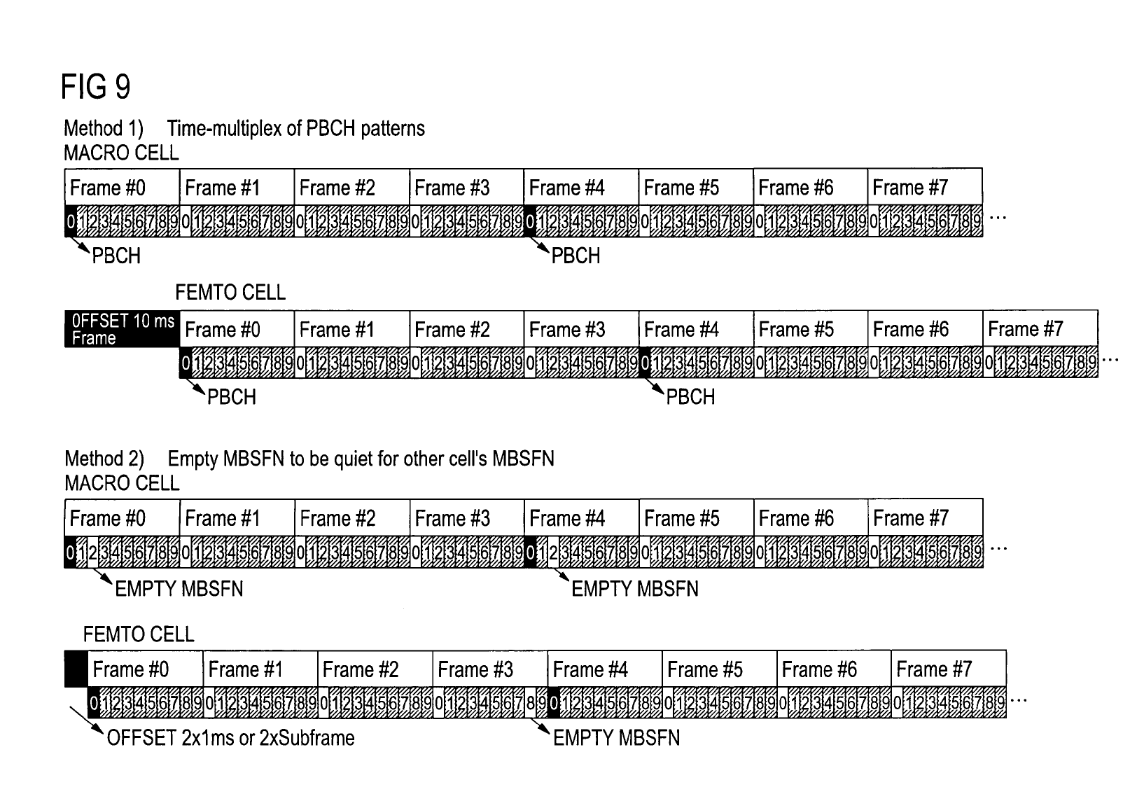

Some of the various embodiments according to the present sub-section 2.4 are illustrated in FIG. 9. “Method 1)” of FIG. 9 illustrates that the time offset is 10 ms (frame of 10 sub-frames or 10 TTI). The PBCH is repeated in multiples (e.g. 4) of 10 ms frames. The time offset between two cells of 10 sub-frames shifts the periodic pattern such that the patterns are time-multiplexed. Furthermore, “Method 2)” of FIG. 9 illustrates that the time offset is N*1 ms, wherein N cannot be multiples of 5. Here, the PBCH of one cell falls in frequency and time resource onto the PDSCH/PMCH of the other channel and vice versa. Accordingly, an EMPTY MBSFN can be configured in one cell (macro or femto) such that the PBCH in the other cell (femto or macro) is not interfered.

3. Femto Cell Adapts to Macro Cell Set-Up for Hosting Femto Deployments

Despite the fact that there is a coordination scheme based on the combination of different methods into imperfect pairs or groups of allocation sets (in particular between the macro cell and the femto cell in use case 2) it is not desirable that the macro cell must permanently interact with the femto deployment for resource management.

According to certain embodiments, the presented approach provides for the macro cell:
After network planning, a macro cell can be configured for hosting femto deployment.
The following static configurations and settings are made: Based on the macro PCI valid PDCCH/PCFICH/PHICH pairs or groups of allocation sets in accordance to section 2.2 are calculated and stored in the operator's O&M database.
During configuration, the macro cell then receives
   its PDCCH/PCFICH/PHICH allocation pattern based on the femto mini-CCE reservations,
   its C-RNTI set,
   PDSCH allocation preference area,
   and, based on O&M decision, a constructed or an exhaustively generated set of femto PCIs to profile the DL power mask in case of collisions. Depending on the collision management selected for PCFICH and CRS, the Femto PCI set will be a constructed one or an exhaustively searched one.
Also, the macro cell may be set-up for always intermitting an empty MBSFN in e.g. in a 40 ms repetitive pattern in order to allow the femto UEs to hear their own broadcast and synchronization channels un-interfered.

According to certain embodiments, the presented approach provides for the femto cell:
A femto cell being newly deployed will be able to synchronize on the macro cell. This information is reported to the O&M and the femto cell receives its:
   PCI from among the few allowed PCIs in this macro cell,
   PDCCH/PCFICH/PHICH allocation pattern based on the mini-CCE reservations of the macro cell,
   C-RNTI set, and
   PDSCH allocation preference area.

While the femto cell synchronizes with the macro cell and seeks to create (when applicable) a sub-frame time shift, there is no need that the macro cell interacts with the femto cells.

Similarly, femto cells in an office environment interfering with each other can be coordinated semi-statically after having been set-up, if it is assumed that an O&M system knows (successively via a self organized network) about the neighbor relationships of the femto cells in the office environment (use case 3).

As indicated above, implementations examples for certain embodiments of the present invention include base station equipment for WA and LA cells such as LTE eNB and HeNB, but are not limited thereto.

According to the above description, it should thus be apparent that exemplary embodiments of the present invention provide, for example from the perspective of a network element such as an evolved Node B (eNB), a Home evolved Node B, and/or a network planning element such as a O&M entity, or a component thereof, an apparatus embodying the same, a method for controlling and/or operating the same, and computer program(s) controlling and/or operating the same as well as mediums carrying such computer program(s) and forming computer program product(s).

For example, described above are apparatuses, methods and computer program products capable of providing control channel coordination in heterogeneous networks.

Implementations of any of the above described blocks, apparatuses, systems, techniques or methods include, as non limiting examples, implementations as hardware, software, for example in connection with a digital signal processor, firmware, special purpose circuits or logic, general purpose hardware or controller or other computing devices, or some combination thereof.

What is described above is what is presently considered to be preferred embodiments of the present invention. However, as is apparent to the skilled reader, these are provided for illustrative purposes only and are in no way intended that the present invention is restricted thereto. Rather, it is the intention that all variations and modifications be included which fall within the spirit and scope of the appended claims.

1. An apparatus, comprising:
parameter provision means configured to provide parameter indicating the availability of resources, wherein a resource is defined as an available radio frequency per time interval, and parameter indicating the configuration of a physical channel configured for downlink control, for a physical control channel configured for format indication, and for a physical channel configured for hybrid automatic repeat request indication, respectively, for use in both of two different communication cells for providing radio communication services for terminals located in said cells; and
determining means configured to determine a first re-source allocation set and a second resource allocation set, wherein the first resource allocation set and the second resource allocation set respectively comprise resource allocations for a physical channel configured for downlink control, for a physical control channel configured for format indication, and for a physical channel configured for hybrid automatic repeat request indication, and wherein the determining means is configured to determine the first resource allocation set and the second resource allocation set to be as mutually disjoint in resource allocation as possible in consideration of the parameters provided by the parameter provision means .

2. The apparatus according to claim 1, wherein the two different communication cells are selected from a group comprising a macro communication cell and a femto or pico communication cell, or comprising two or more femto or pico communication cells in a local area deployment.

3. The apparatus according to claim 1, wherein the determining means is further configured to determine the first resource allocation set and the second resource allocation set to be as mutually disjoint in resource allocation as possible by suitably selecting a physical cell identity for the second communication cell, by filling a string of control channel elements forming the physical channel configured for downlink control of the first communication cell with dummy terminal-related control channel elements where a control channel element string of the physical channel configured for downlink control of the second communication cell has its terminal-related control channel elements and vice versa, and by controlling a terminal search space on the physical channels configured for downlink control within both communication cells based on a pre-defined set of cell radio network temporary identifier for the first communication cell and a pre-defined set of cell radio network temporary identifier for the second communication cell.

4. An apparatus, comprising:
detecting means configured to detect a first resource allocation set and a second resource allocation set, wherein a resource is defined as an available radio frequency per time interval, and wherein the first resource allocation set and the second resource allocation set respectively comprise resource allocations for a physical channel configured for downlink control, for a physical control channel configured for format indication, and for a physical channel configured for hybrid automatic repeat request indication; and
controlling means configured to control a power of signal transmission on the physical channels reflected in the first resource allocation set in relation to the second resource allocation set such that a power of signal transmission differs in dependency on whether resource allocations in the first resource allocation set and the second resource allocation set are disjoint.

5. The apparatus according to claim 4, wherein the controlling means are configured to control a power of signal trans- mission such that a power of signal transmission is higher where resource allocations in the first resource allocation set and the second resource allocation set are disjoint, and a power of signal transmission is lower where resource allocations in the first resource allocation set and the second resource allocation set are not disjoint.

6. The apparatus according to claim 4, wherein the controlling means are configured to control a power of signal transit) mission such that a power of signal transmission is lower where resource allocations in the first resource allocation set and the second resource allocation set are disjoint, and a power of signal transmission is higher where resource allocations in the first resource allocation set and the second resource allocation set are not disjoint.

7. An apparatus, comprising:
synchronization means configured to synchronize in time an internal channel transmission clock with an external channel transmission clock; and
channel transmission means configured to introduce a time domain offset in downlink channel transmission of a physical channel configured for broadcast as well as of synchronization signals of a first communication cell with respect to downlink channel transmission of a physical channel configured for broadcast as well as of the synchronization signals of a second communication cell.

8. The apparatus according to claim 7, wherein a given time structure of the first communication cell's channel transmission of the physical channel configured for broadcast comprising a periodically recurring pattern built on a frame- and-sub-frame-structure and an analogous given time structure of the second communication cell's channel transmission of the physical channel configured for broadcast are exploited to configure a time domain offset as one frame length in time or as positive integer-multiple thereof, such that the physical channel configured for broadcast of the first and the second communication cells are interleaved and do not collide .

9. The apparatus according to claim 7, wherein each of the two or more communication cell's channel transmissions of the physical channel configured for broadcast with a time structure built on a frame structure with ten sub-frames are configured /with a mutual time domain offset which is N times the time length of one sub-frame, wherein N is a positive integer but cannot be multiples of five, and wherein in one communication cell's channel transmission a physical channel configured for shared downlink and a physical channel configured for multicast which collide in time and frequency with the other cell's channel transmission of the physical channel configured for broadcast are muted by introducing an empty multimedia broadcast over single frequency network sub-frame for each M-th frame interval time length, wherein M is a positive integer.

10. A method, comprising:
providing parameter indicating the availability of resources, wherein a resource is defined as an available radio frequency per time interval, and parameter indicating the configuration of a physical channel configured for downlink control, for a physical control channel configured for format indication, and for a physical channel configured for hybrid automatic repeat request indication, respectively, for use in both of two different communication cells for providing radio communication services for terminals located in said cells; and
determining a first resource allocation set and a second resource allocation set, wherein the first resource allocation set and the second resource allocation set respectively comprise resource allocations for a physical channel configured for downlink control, for a physical control channel configured for format indication, and for a physical channel configured for hybrid automatic repeat request indication, and wherein the first resource allocation set and the second resource allocation set are determined to be as mutually disjoint in resource allocation as possible in consideration of the parameters provided by the parameter provision means.

11. The method according to claim 10, wherein the two different communication cells are selected from a group comprising a macro communication cell and a femto or pico communication cell, or comprising two or more femto or pico communication cells in a local area deployment.

12. The apparatus according to claim 10, wherein the determining the first resource allocation set and the second resource allocation set to be as mutually disjoint in resource allocation as possible includes suitably selecting a physical cell identity for the second communication cell, filling a string of control channel elements forming the physical channel configured for downlink control of the first communication cell with dummy terminal-related control channel elements where a control channel element string of the physical channel configured for downlink control of the second communication cell has its terminal-related control channel elements and vice versa, and controlling a terminal search space on the physical channels configured for downlink control within both communication cells based on a predefined set of cell radio network temporary identifier for the first communication cell and a pre-defined set of cell radio network temporary identifier for the second communication cell.

13. A method, comprising:
detecting a first resource allocation set and a second resource allocation set, wherein a resource is defined as an available radio frequency per time interval, and wherein the first resource allocation set and the second resource allocation set respectively comprise resource allocations for a physical channel configured for downlink control, for a physical control channel configured for format indication, and for a physical channel configured for hybrid automatic repeat request indication; and
controlling a power of signal transmission on the physical channels reflected in the first resource allocation set in relation to the second resource allocation set such that a power of signal transmission differs in dependency on whether resource allocations in the first resource allocation set and the second resource allocation set are disjoint.

14. The method according to claim 13, wherein the controlling further includes controlling a power of signal transmission such that a power of signal transmission is higher where resource allocations in the first resource allocation set and the second resource allocation set are disjoint, and a power of signal transmission is lower where resource allocations in the first resource allocation set and the second resource allocation set are not disjoint.

15. The method according to claim 13, wherein the controlling further includes controlling a power of signal transmission such that a power of signal transmission is lower where resource allocations in the first resource allocation set and the second resource allocation set are disjoint, and a power of signal transmission is higher where resource allocations in the first resource allocation set and the second resource allocation set are not disjoint.

16. A method, comprising:
synchronizing in time an internal channel transmission clock with an external channel transmission clock;
introducing a time domain offset in downlink channel transmission of a physical channel configured for broadcast as well as of synchronization signals of a first communication cell with respect to downlink channel transmission of a physical channel configured for broadcast as well as of the synchronization signals of a second communication cell.

17. The method according to claim 16, wherein a given time structure of the first communication cell's channel transmission of the physical channel configured for broadcast comprising a periodically recurring pattern built on a frame-and-sub-frame-structure and an analogous given time structure of the second communication cell's channel transmission of the physical channel configured for broadcast are exploited to configure a time domain offset as one frame length in time or as positive integer-multiple thereof, such that the physical channel configured for broadcast of the first and the second communication cells are interleaved and do not collide .

18. The method according to claim 16, wherein each of the two or more communication cell's channel transmissions of the physical channel configured for broadcast with a time structure built on a frame structure with ten sub-frames are configured with a mutual time domain offset which is N times the time length of one sub-frame, wherein N is a positive integer but cannot be multiples of five, and wherein in one communication cell's channel transmission a physical channel configured for shared downlink and a physical channel configured for multicast which collide in time and frequency with the other cell's channel transmission of the physical channel configured for broadcast are muted by introducing an empty multimedia broadcast over single frequency network sub-frame for each M-th frame interval time length, wherein M is a positive integer.

19. An evolved Node B, comprising an apparatus according to claim 4.

20. A central network entity, comprising an apparatus according to claim 1.

21. A computer program product comprising computer-executable components which perform, when the program is run on a computer :
providing parameter indicating the availability of resources, wherein a resource is defined as an available radio frequency per time interval, and parameter indicating the configuration of a physical channel configured for downlink control, for a physical control channel configured for format indication, and for a physical channel configured for hybrid automatic repeat request indication, respectively, for use in both of two different communication cells for providing radio communication services for terminals located in said cells; and
determining a first resource allocation set and a second resource allocation set, wherein the first resource allocation set and the second resource allocation set respectively comprise resource allocations for a physical channel configured for downlink control, for a physical control channel configured for format indication, and for a physical channel configured for hybrid automatic repeat request indication, and wherein the first resource allocation set and the second resource allocation set are determined to be as mutually disjoint in resource allocation as possible in consideration of the parameters provided by the parameter provision means.

22. The computer program product according to claim 21, wherein the determining the first resource allocation set and the second resource allocation set to be as mutually disjoint in resource allocation as possible includes suitably selecting a physical cell identity for the second communication cell, filling a string of control channel elements forming the physical channel configured for downlink control of the first communication cell with dummy terminal-related control channel elements where a control channel element string of the physical channel configured for downlink control of the second communication cell has its terminal-related control channel elements and vice versa, and controlling a terminal search space on the physical channels configured for downlink control within both communication cells based on a pre-defined set of cell radio network temporary identifier for the first communication cell and a pre-defined set of cell radio network temporary identifier for the second communication cell.

23. A computer program product comprising computer-executable components which perform, when the program is run on a computer :
detecting a first resource allocation set and a second resource allocation set, wherein a resource is defined as an available radio frequency per time interval, and wherein the first resource allocation set and the second resource allocation set respectively comprise resource allocations for a physical channel configured for downlink control, for a physical control channel configured for format indication, and for a physical channel configured for hybrid automatic repeat request indication; and
controlling a power of signal transmission on the physical channels reflected in the first resource allocation set in relation to the second resource allocation set such that a power of signal transmission differs in dependency on whether resource allocations in the first resource allocation set and the second resource allocation set are disjoint.

24. A computer program product comprising computer-executable components which perform, when the program is run on a computer:
synchronizing in time an internal channel transmission clock with an external channel transmission clock;
introducing a time domain offset in downlink channel transmission of a physical channel configured for broadcast as well as of synchronization signals of a first communication cell with respect to downlink channel transmission of a physical channel configured for broadcast as well as of the synchronization signals of a second communication cell.

25. The computer program product according to claim 21, embodied as a computer-readable storage medium.
